(19) United States
(12) Patent Application Publication
(10) Pub. No.: US 2024/0101781 A1
(43) Pub. Date: Mar. 28, 2024

(54) METHOD OF PRODUCING STYRENE MONOMERS BY DEPOLYMERIZATION OF A STYRENE-COPOLYMER-CONTAINING POLYMER MASS

(71) Applicant: INEOS STYROLUTION GROUP GMBH, Frankfurt am Main (DE)

(72) Inventors: Norbert NIESSNER, Friedelsheim (DE); Bianca WILHELMUS, Hanau (DE); Thomas W. COCHRAN, Wilmington, IL (US)

(21) Appl. No.: 17/769,010

(22) PCT Filed: Oct. 13, 2020
(86) PCT No.: PCT/EP2020/078707

§ 371 Date: Apr. 14, 2022

(30) Foreign Application Priority Data
Oct. 15, 2019 (EP) 19203427.0

(51) Int. Cl. C08J 11/12; C08F 212/08

(52) U.S. Cl. CPC C08J 11/12; C08F 212/08; C08F 2800/20

(57) ABSTRACT

The invention relates to a method of producing styrene monomers by depolymerization (breakdown) of a styrene-copolymer-containing polymer mass, a device for carrying out the method, the use of a styrene copolymer for producing styrene monomers by thermal depolymerization and the use of a styrene copolymer as an additive in the thermal depolymerization of polystyrene. The polymer mass contains I) 10 to 100 wt %, relative to the total weight of the polymer mass (A), of a styrene copolymer (I), comprising: Ia) 10 to 99 wt %, relative to the styrene copolymer (I), of repeating units (Ia) that originate from styrene; and Ib) 1 to 90 wt %, relative to the styrene copolymer (I), of repeating units (Ib) that originate from a monomer the homopolymers of which have a ceiling temperature of below 350° C.; and II) optionally 0 to 90 wt % polystyrene (II).

The invention relates to a process for the production of styrene monomers by depolymerization (breakdown) of a styrene-copolymer-containing polymer mass, to an apparatus for conducting the process, to the use of a styrene copolymer for the production of styrene monomers by thermal depolymerization and also to the use of a styrene copolymer as an additive in the thermal depolymerization of polystyrene.

The transition from a linear to a circular economy is necessary both ecologically and economically from the viewpoints of climate change, environmental pollution, population growth and dependence on resources. As early as in the 1980s and 1990s, intense efforts were directed towards the development of processes for the raw-material recycling of plastics wastes, but no industrial applications have arisen to date due to unresolved process-technological problems and for economic reasons. Due to generally increasing environmental awareness and the rising need for sustainable solutions, however, interest in chemical recycling is growing as well.

Not all thermoplastic polymers are equally well suited to chemical recycling. The thermal decomposition of polyolefins or polyesters forms mixtures of, inter alia, waxes, light oil and gases. The breakdown of polyethylene terephthalate (PET) results in organic acids, predominantly benzoic acid and terephthalic acid, which are corrosive and may also cause blockage of the reactor (G. Grause et al., Feedstock recycling of waste polymeric material, in: Journal of Material Cycles and Waste Management, 13(4), 2011, 265-282).

In the case of polystyrene and other styrene-containing polymers, it is possible to depolymerize these polymers into their base constituents, especially styrene monomers, and for this reason polystyrene and other styrene-monomer-containing polymers represent an exceptional choice for chemical recycling. However, the product mixture resulting from a depolymerization process must be purified in order to use the components as a feedstock for new purposes, such as polymerization processes.

When polystyrene is thermally treated to a sufficient extent, it decomposes into styrene monomers, but incomplete decomposition also leads to the formation of, for example, styrene dimers and trimers and other oligomers.

If the decomposition conditions are too harsh, byproducts such as benzene, toluene, ethylbenzene, cumene and alpha-methylstyrene may be formed. The amounts of these reaction products vary and depend in particular on the reaction conditions and the feedstocks used (see C. Bouster et al., Study of the pyrolysis of polystyrenes: Kinetics of thermal decomposition, in: Journal of Analytical and Applied Pyrolysis, 1 (1980) 297-313 and C. Bouster et al., Evolution of the product yield with temperature and molecular weight in the pyrolysis of polystyrene, in: Journal of Analytical and Applied Pyrolysis 15 (1989) 249-259).

The styrene monomers obtained can be used for a new polymerization process. Styrene oligomers may possibly disrupt the polymerization process, since they influence important properties of the polymer even in small amounts. This also applies to other byproducts. Therefore, the styrene monomers must be separated from other components of the product mixture in order to ensure a high product quality.

In particular, aromatic compounds other than styrene monomers can act as chain transfer agents in free-radical polymerization processes, which lower the average molecular weight of the polymers produced and contribute to polymers having a lower glass transition temperature (Tg) (DS Achilias et al., Chemical recycling of polystyrene by pyrolysis: Potential use of the liquid product for the reproduction of polymer, in: Macromolecular Materials and Engineering, 292(8) (2007), 923-934). Protons from e.g. carboxylic acids, alcohols, aldehydes or ketones act as terminators in anionic polymerization processes of styrene (D. Baskaran et al., Anionic Vinyl Polymerization, in: Controlled and Living Polymerizations: From Mechanisms to Applications, John Wiley & Sons, 2009, 1-56).

JP 2005132802 and JPH 11100875 (Toshiba Plant Systems) describe processes for the recovery of styrene from polystyrene wastes, however, no solution is provided for the separation of low boilers, styrene and high boilers.

There is a great need for a process for the production of styrene monomers by depolymerization of styrene-(co)polymer-containing polymer masses, which affords styrene in a very high yield and in which the formation of styrene oligomers is kept to a minimum, in order to minimize the subsequent purification process.

Surprisingly, it has been found that polymer masses containing certain copolymers of styrene can be depolymerized much more rapidly and/or better than polymer masses without these copolymers.

One subject of the invention is thus a process for the production of styrene monomers by depolymerization of a styrene-copolymer-containing polymer mass, comprising the steps of:
a) introducing a polymer mass (A) containing:
   I) 10% to 100% by weight, based on the total weight of the polymer mass (A), of a styrene copolymer (I), comprising
   Ia) 10% to 99% by weight, based on the styrene copolymer (I), of repeating units (Ia) which originate from styrene; and
   Ib) 1% to 90% by weight, based on the styrene copolymer (I), of repeating units (Ib) which originate from a monomer the homopolymers of which have a ceiling temperature of below 350° C.;
   II) optionally 0% to 90% by weight, based on the total weight of the polymer mass (A), of polystyrene (II), into the reaction zone (R) of a pyrolysis reactor (P);
b) thermally cleaving the styrene copolymer (I) present in the polymer mass (A) and the polystyrene (II) optionally present in the polymer mass (A) in the reaction zone (R) of the pyrolysis reactor (P) at a temperature of from 300° C. to 1000° C., preferably from 380° C. 20 to 700° C., particularly preferably from 400° C. to 650° C., very particularly preferably from 450° C. to 580° C., in order to obtain a product mixture (G) containing styrene monomers and further components;
c) withdrawing the product mixture (G) obtained in step b) from the reaction zone (R) of the pyrolysis reactor (P);
d) cooling the product mixture (G) withdrawn in step c), in order to obtain a condensed product mixture (G) containing styrene monomers and further components; and
e) separating the styrene monomers from the further components of the condensed product mixture (G) obtained in step d).

The thermal decomposition (depolymerization) of the polystyrene can take place in any suitable reactor in which the temperature required for the decomposition can be achieved.

For example, the pyrolysis reactor (P) may be selected from the group consisting of extruders, batch reactors, rotating tubes, microwave reactors, shell and tube reactors, vortex reactors and fluidized bed reactors. For example, the thermal decomposition can be performed in a rotary kiln. Rotary kilns are described for example in EP-A 1481957. The thermal decomposition may also take place in extruders; these are described for example in EP-A 1966291. Such reactors can be operated with or without a gas stream, such as carrier gas or gas as reaction medium.

The pyrolysis reactor (P) can accordingly be any known type of pyrolysis reactor, with the proviso that the design of the pyrolysis reactor allows a precise setting of the temperature in the reaction zone (R) of the pyrolysis reactor (P).

In one embodiment, the residence time (Z) of the polymer mass (A) in the reaction zone (R) of the pyrolysis reactor (P) is from 0.01 s to 50 s, often 0.1 s to 10 s, at a temperature of from 300° C. to 1000° C.

In a preferred embodiment, the residence time (Z) of the polymer mass (A) in the reaction zone (R) of the pyrolysis reactor (P) is from 0.1 s to 10 s, often 0.1 s to 5 s, at a temperature of from 380° C. to 700° C.

In a particularly preferred embodiment, the residence time (Z) of the polymer mass (A) in the reaction zone (R) of the pyrolysis reactor (P) is from 0.2 s to 5 s, at a temperature of from 400° C. to 650° C.

In a very particularly preferred embodiment, the residence time (Z) of the polymer mass (A) in the reaction zone (R) of the pyrolysis reactor (P) is from 0.4 s to 2 s, at a temperature of from 450° C. to 630° C.

The temperature can be set in any known way, for example by microwave irradiation, using heat exchangers, gas burners, resistive heating conductors (resistance heating), or by introducing superheated gas, in particular steam, in each case on their own or in combination. In one embodiment, the temperature is set using resistive heating conductors which are in contact with the wall of the reaction zone (R) of the pyrolysis reactor (P).

Alternatively, the temperature can be set using steam, which is provided by evaporating water and is brought to the desired temperature by means of a steam superheater. In one embodiment, a combination of resistive heating conductors, which are in contact with the wall of the reaction zone (R) of the pyrolysis reactor (P), and steam is used to set the temperature in the reaction zone (R) of the pyrolysis reactor (P).

In a preferred embodiment, the pyrolysis reactor (P) is a fluidized bed reactor, preferably comprising an SiC fluidized bed in the reaction zone (R) thereof, the temperature in the reaction zone (R) being set by introducing steam having the desired temperature. In this embodiment, the steam is provided by an evaporator and is brought to the desired temperature by means of a steam superheater. In this embodiment, the steam is also used both to set the temperature in the reaction zone (R) and to create the fluidized bed.

Optionally, in this embodiment, the heat energy in the reaction zone (R) can be additionally provided by resistive heating conductors which are in contact with the wall of the reaction zone (R) of the pyrolysis reactor (P).

The particle size of the particles and the concentration of the polymer mass (A) in the reaction zone (R) can be adapted to the specific conditions of the reactor and its configuration, to the reaction conditions and to the composition of the polymer mass (A).

The polymer mass (A) typically has a particle size of between 100 μm and 50 mm, preferably between 250 μm and 5 mm, particularly preferably between 500 μm and 3 mm. The particles may be of spherical or nonspherical form. In the case of a spherical form, the particle size is determined by measuring the volume-average diameter. In the case of nonspherical particles, for example needle-shaped particles, the longest dimension is used for determination of the particle size.

The concentration of the reaction material in the reactor depends on the reactor type, the reactor size and the reactor configuration. The concentration of the polymer mass (A) in the reaction zone (R) of the pyrolysis reactor (P) is typically between 1% and 50% by weight, preferably between 1% and 25% by weight, particularly preferably between 1% and 10% by weight, very particularly preferably between 2% and 7% by weight.

Preferably, the polymer mass (A) in step a) is pneumatically fed into the reaction zone (R) of the pyrolysis reactor (P), mixed with the fluidized bed of silicon carbide and finally depolymerized in step b). Particular preference is given to continuously feeding the polymer mass (A) in step a).

During the residence time (Z) in the reaction zone (R) of the pyrolysis reactor (P), the polystyrene component and possibly other polymers in the polymer mass (A) are at least partly depolymerized (broken down) in order to give a product mixture (G) containing styrene monomers and other components.

The product mixture (G) containing styrene monomers and other components is withdrawn from the reaction zone (R) of the pyrolysis reactor (P) in step c). Withdrawal preferably takes place continuously. Particularly preferably, the product mixture (G) is continuously withdrawn in the gas state from the upper region of the reaction zone (R) of the pyrolysis reactor (P). In this case, the product mixture (G) may for example be withdrawn automatically by transport of the product mixture (G) out of the reaction zone (R) due to the elevated pressure in the reaction zone (R) brought about by the reaction.

The pyrolysis reactor may contain a quencher or be connected to a quencher. In this context, a quencher is understood to be a region of the pyrolysis reactor in which the depolymerization reaction is rapidly halted, preferably by cooling the hot gas consisting of the product mixture (G) and inert gas stream, for example steam. The quencher serves, inter alia, for stabilization of the reaction products and for preventing or reducing undesired repolymerization. Typical quenchers cool the product mixture (G) from a temperature of more than 300° C. to a temperature of less than 250° C. within a very short time, preferably within fewer than 10 seconds, particularly preferably within fewer than 5 seconds, particularly preferably within less than 1 second. Quenchers are described for example in EP-A 1966291.

The product mixture (G) is cooled down after withdrawal from the reaction zone (R) of the pyrolysis reactor (P), resulting in the condensation of the styrene monomers and further components and the obtaining of a condensed product mixture (G′) containing styrene monomers and further components. The product mixture (G) is cooled down to a temperature below the condensation point of styrene monomers.

The product mixture (G) is preferably cooled to a temperature below 70° C., particularly preferably below 50° C., very particularly preferably below 40° C. In a preferred embodiment, the product mixture (G) is cooled to a temperature of from 0° C. to 70° C. In a particularly preferred embodiment, the product mixture (G) is cooled to a temperature of from 0° C. to 50° C. In a very particularly preferred embodiment, the product mixture (G) is cooled to a temperature of from 15° C. to 40° C.

The cooling can be effected in any known manner. For example, cooling on a solid surface which is cooled by water or air is possible. Likewise possible is cooling by means of a water mist which is brought directly into contact with the product mixture (G). The cooling preferably takes place in a water mist. Here, the condensable constituents of the product mixture (G) are condensed according to their vapor pressures and collected together with the water.

A condensed product mixture (G′) containing styrene monomers and further constituents is obtained in the condensation.

In the case of cooling in a water mist, the condensed product mixture (G′) is obtained as a two-phase system with the cooling water. In this case, the condensed product mixture (G) is separated from the aqueous phase as a floating organic phase. The aqueous phase can be cooled again and used as water mist for cooling the product mixture (G).

In the further course of the process, for example, the condensed product mixture (G′) is separated into styrene monomers and further constituents. This separation can be conducted in any known manner which is suitable for separating mixtures of liquid products and possibly solids into their constituents. Depending on the further constituents besides styrene monomers, suitable methods for separating the condensed product mixture (G) into styrene monomers and further constituents may for example comprise sedimentation, centrifugation, filtration, decantation, distillation, chromatography, crystallization and sublimation.

If solids are present in the condensed product mixture (G), it is advantageous to remove the solids prior to separation of the liquid constituents. In this case it is preferable to remove the solids from the liquid constituents by sedimentation, centrifugation, filtration, distillation, sublimation and/or decantation, preferably by filtration, particularly preferably by filtration using a solid-liquid filter.

The further separation of the liquid constituents into styrene monomers and further constituents preferably comprises at least one step of distillation, such as for example fractional distillation, at least one step of chromatography, such as for example column chromatography, HPLC or flash chromatography, and/or at least one step of crystallization, such as for example fractional crystallization. Particularly preferably, the separation of the liquid constituents comprises at least one step of distillation, very particularly preferably at least one step of fractional distillation.

In a preferred embodiment, the separation of the liquid constituents into styrene monomers and further components comprises at least one step of fractional distillation in one or more rectifying columns.

It is often advantageous to recycle at least a portion of the further components into the reaction zone (R) of the pyrolysis reactor (P). This is advantageous in particular when a portion of the further constituents contains styrene oligomers such as for example styrene dimers and styrene trimers. This allows an overall better yield of styrene monomers since the depolymerization of the remaining oligomers is made possible as a result as well. For this reason, it is preferable for at least a portion of the further components of the condensed product mixture (G), which have been separated from styrene monomers, to be recycled into the reaction zone (R) of the pyrolysis reactor (P). Particular preference is given here to a continuous recycling of the further components.

In a preferred embodiment, the further components which are recycled into the reaction zone (R) of the pyrolysis reactor (P) essentially consist of styrene oligomers, preferably of styrene dimers and styrene trimers. In this context, “essentially” means that the further components which are recycled into the reaction zone (R) of the pyrolysis reactor (P) do not contain any further components which disrupt the depolymerization process in the reaction zone (R) of the pyrolysis reactor (P) besides styrene oligomers. The remaining constituents which are not recycled into the reaction zone (R) of the pyrolysis reactor (P) typically comprise the monomers from which the repeating units (Ib) originate, preferably methyl methacrylate and/or alpha-methylstyrene.

The polymer mass (A) used in the process according to the invention in particular contains:
I) 10% to 100% by weight, preferably 30% to 100% by weight, particularly preferably 50% to 100% by weight, very particularly preferably 70% to 90% by weight, based on the total weight of the polymer mass (A), of at least one styrene copolymer (I)
II) optionally 0% to 90% by weight, preferably 0% to 70% by weight, particularly preferably 0% to 50% by weight, very particularly preferably 0% to 30% by weight, based on the total weight of the polymer mass (A), of polystyrene (II).

The lower limit of polystyrene is often 1% by weight, 5% by weight or 10% by weight.

If polystyrene (II) is present in the polymer mass (A), the polystyrene (II) consists of GPPS (general purpose polystyrene) and/or HIPS (high impact polystyrene).

The styrene copolymer (I) is a copolymer comprising
Ia) 10% to 99% by weight, preferably 50% to 99% by weight, particularly preferably 70% to 98% by weight, very particularly preferably 70% to 85% by weight, based on the styrene copolymer (I), of styrene; and
Ib) 1% to 90% by weight, preferably 1% to 50% by weight, particularly preferably 2% to 30% by weight, very particularly preferably 15% to 30% by weight, based on the styrene copolymer (I), of repeating units (Ib) which originate from a monomer the homopolymers of which have a ceiling temperature of below 350° C., preferably of below 300° C.;
Ic) 0% to 10% by weight, preferably 0% to 5% by weight, particularly preferably 0% to 3% by weight, of further copolymerizable monomers, for example selected from, but not restricted to, maleic anhydride, N-phenylmaleimide, para-methylstyrene, (meth)acrylonitrile, alkyl acrylate.

The ceiling temperature is the temperature at which the rate of polymerization is equal to the rate of depolymerization. For polyethylene, this ceiling temperature (T a) is approx. 883 K (610° C.), for polystyrene it is approx. 669 K (396° C.).

The repeating units (Ib) present in the styrene copolymer (I) may in general be repeating units which originate from any monomer the homopolymers of which have a ceiling temperature of below 350° C., provided that the monomers have a polymerizable unsaturated aliphatic group. Preferably, the repeating units (Ib) originate from methyl methacrylate and/or alpha-methylstyrene, particularly preferably from methyl methacrylate. When repeating units (Ib) originating from alpha-methylstyrene are present in the styrene copolymer (I), the proportion of alpha-methylstyrene in the styrene copolymer is preferably from 1% to 55% by weight, particularly preferably from 1% to 30% by weight, based on the styrene copolymer (I).

In addition to the styrene copolymer (I) and optionally the polystyrene (II), the polymer mass (A) may additionally contain further components. These may be further polymeric components and also non-polymeric components.

If, in addition to the styrene copolymer (I) and optionally the polystyrene (II), further components are additionally present in the polymer mass (A), the polymer mass (A) comprises
III) at most 30% by weight, preferably at most 20% by weight, particularly preferably at most 10% by weight, based on the total weight of the polymer mass (A), of polyolefins II);
IV) at most 4.9% by weight, preferably at most 2% by weight, particularly preferably at most 1% by weight, based on the total weight of the polymer mass (A), of acrylonitrile-based polymers (IV); and
V) at most 4.9% by weight, preferably at most 2% by weight, particularly preferably at most 1% by weight, based on the total weight of the polymer mass (A), of polyesters (V).

Useful as polyolefin (III), when present, are any polyolefins, for example polyethylene or polypropylene derivatives such as PE-LD (low-density polyethylene), PE-LLD (linear low-density poly-ethylene), PE-HD (high-density polyethylene), metallocene polyethylenes, ethylene copolymers such as poly(ethylene-co-vinyl acetate), ethylene-butene, ethylene-hexene, ethylene-octene copolymers, and also cycloolefin copolymers, homo- or copolymers of propylene, metallocene-catalyzed polypropylenes and copolymers of propylene with other comonomers known to those skilled in the art, and mixtures thereof. Preferred polyolefins (III) are homopolymers of ethylene, homopolymers of propylene, copolymers of ethylene and propylene, and mixtures thereof.

Useful as acrylonitrile-based polymer (IV), when present, are any acrylonitrile-based polymers, for example styrene-acrylonitrile copolymers (SAN), α-methylstyrene-acrylonitrile copolymers (AMSAN), styrene-acrylonitrile-maleic anhydride copolymers, styrene-acrylonitrile-phenylmaleimide copolymers, and graft copolymers thereof with rubber-like polymers, for example acrylonitrile-butadiene-styrene graft copolymers (ABS), acrylonitrile-styrene-alkyl (meth)acrylate graft copolymers (ASA), α-methylstyrene-acrylonitrile-methyl methacrylate copolymers, α-methylstyrene-acrylonitrile-t-butyl methacrylate copolymers and styrene-acrylonitrile-t-butyl methacrylate copolymers.

Preferred acrylonitrile-based polymers (IV), when present, are styrene-acrylonitrile copolymers (SAN), acrylonitrile-styrene-alkyl acrylate graft copolymers (ASA) and acrylonitrile-butadiene-styrene graft copolymers (ABS).

Useful as polyester (V), when present, are any polyesters, for example polycondensation products of dicarboxylic acids containing 4 to16 carbon atoms with diols containing 2 to 8 carbon atoms or polycondensation products of hydroxycarboxylic acids containing 2 to 6 carbon atoms. These include, inter alia, polyalkylene adipates, such as polyethylene adipate and polybutylene adipate, polyalkylene terephthalates, such as polyethylene terephthalate and polybutylene terephthalate, polylactic acid, polyhydroxybutyrates, polycaprolactones and polyvalerolactones. Preferred polyesters (V), when present, are polyethylene terephthalate (PET) and polybutylene terephthalate (PBT), especially polyethylene terephthalate.

In a particularly preferred embodiment, the polymer mass (A) contains in total at most 2% by weight, based on the total weight of the polymer mass (A), of acrylonitrile-based polymer (IV) and polyester (V).

In a very particularly preferred embodiment, the polymer mass (A) contains in total at most 1% by weight, based on the total weight of the polymer mass (A), of acrylonitrile-based polymer (IV) and polyester (V).

Preferably, the polymer mass (A) contains no polymeric components other than the styrene copolymer (I), polystyrene (II), polyolefin (III), acrylonitrile-based polymer (IV) and/or polyester (V).

The polymer mass (A) particularly preferably contains no further polymeric components besides the styrene copolymer (I) and optionally polystyrene (II).

In addition, the polymer mass (A) may contain up to 30% by weight, based on the total weight of the polymer mass (A), of additive(s).

The polymer mass (A) preferably contains up to 10% by weight, especially 0.3% to 8% by weight, particularly preferably up to 4% by weight, especially 0.3% to 4% by weight, based on the total weight of the polymer mass (A), of additive(s).

As additives, customary plastics additives and auxiliaries may be present in the polymer mass (A). By way of example, an additive or an auxiliary may be selected from the group consisting of antioxidants, UV stabilizers, peroxide destroyers, antistats, lubricants, mold-release agents, flame retardants, fillers or reinforcers (glass fibers, carbon fibers, etc.), colorants and combinations of two or more of these.

As examples of oxidation retarders and heat stabilizers, mention is made of halides of metals of group I of the periodic table, e.g. sodium halides, potassium halides and/or lithium halides, possibly in conjunction with copper(I) halides, e.g. chlorides, bromides, iodides, sterically hindered phenols, hydroquinones, various substituted representatives of these groups and mixtures thereof in concentrations of up to 1% by weight, based on the total weight of the polymer mass (A).

As UV stabilizers, which are generally present in amounts of up to 2% by weight, based on the total weight of the polymer mass (A), mention may be made of various substituted resorcinols, salicylates, benzotriazoles and benzophenones.

Organic dyes such as nigrosin, pigments such as titanium dioxide, phthalocyanines, ultramarine blue and carbon black, may also be present as colorants in the polymer mass (A), and also fibrous and pulverulent fillers and reinforcing agents. Examples of the latter include carbon fibers, glass fibers, amorphous silica, calcium silicate (wollastonite), aluminum silicate, magnesium carbonate, kaolin, chalk, powdered quartz, mica and feldspar.

As nucleating agents, for example, talc, calcium fluoride, sodium phenylphosphinate, aluminum oxide, silicon dioxide and nylon 22 may be present.

Examples of lubricants and mold-release agents, which may generally be used in amounts of up to 1% by weight, based on the total weight of the polymer mass (A), are long-chain fatty acids such as stearic acid or behenic acid, their salts (e.g. Ca stearate or Zn stearate) or esters (e.g. stearyl stearate or pentaerythritol tetrastearate) and also amide derivatives (e.g. ethylenebisstearylamide).

Mineral-based antiblocking agents may moreover be present in amounts of up to 0.1% by weight, based on the total weight of the polymer mass (A). Examples that may be mentioned include amorphous or crystalline silica, calcium carbonate or aluminum silicate.

As processing aid, mineral oil, preferably medicinal white oil, may for example be present in amounts of up to 5% by weight, preferably up to 2% by weight, especially 0.1% to 2% by weight, based on the total weight of the polymer mass (A).

As examples of plasticizers, mention may be made of dioctyl phthalate, dibenzyl phthalate, butyl benzyl phthalate, hydrocarbon oils, N-(n-butyl)benzenesulfonamide and o- and p-tolylethylsulfonamide.

Any of the flame retardants known for the respective thermoplastics may moreover be present, in particular those based on phosphorus compounds.

Furthermore, moisture and/or further inorganic and/or organic foreign constituents, such as for example foodstuff residues, may also be present.

A further subject of the invention is a thermoplastic molding compound suitable for recycling by thermal depolymerization, consisting of
I) 10% to 100% by weight, based on the total weight of the polymer mass (A), of at least one styrene copolymer (I), comprising
Ia) 10% to 99% by weight, based on styrene copolymer (I), of repeating units (Ia) which originate from styrene; and
Ib) 1% to 90% by weight, based on styrene copolymer (I), of repeating units (Ib);
Ic) 0% to 10% by weight, preferably 0% to 5% by weight, particularly preferably 0% to 3% by weight, of further copolymerizable monomers, in particular selected from the group of maleic anhydride, N-phenylmaleimide, para-methylstyrene, (meth)acrylonitrile and alkyl acrylate,
II) optionally 0% to 90% by weight, based on the total weight of the polymer mass (A), of polystyrene (II), wherein
the ceiling temperature of the homopolymer of (Ib) is at least 50 K below the ceiling temperature of the homopolymer of the monomer (Ia).

The preferred variants described above for the process are also correspondingly applicable to the thermoplastic molding compound.

The polymer mass (A) used according to the invention may optionally be pretreated in a suitable manner, for example in order to remove adherent contaminants such as for example foodstuff residues or dirt, moisture and foreign substances such as metals or other substances and composite materials.

This is advantageously effected in a pretreatment, which may comprise one or more of the following steps, where the sequence of the steps is not fixed and steps may also be repeated multiple times: manual impurity sorting, washing, comminution, automatic sorting in suitable plants. Optionally, polymer masses which do not correspond to the polymer mass (A) may also be converted by such a process into a polymer mass (A) used according to the invention.

Preference is therefore also given to an embodiment of the process according to the invention in which a polymer mass which does not correspond to the polymer mass (A) is subjected to a pretreatment, comprising one or more of the following steps, where the sequence of the steps is not fixed and steps may also be repeated multiple times: manual impurity sorting, washing, comminution, automatic sorting in suitable plants, in order to thus obtain the polymer mass (A).

A further subject of the invention is an apparatus for conducting a process for the production of styrene monomers from a styrene-copolymer-containing polymer mass as described above, in which the reaction zone (R) and the pyrolysis reactor (P) in the apparatus are configured such that gentle depolymerization of styrene copolymer and (optionally) polystyrene is possible.

The apparatus preferably comprises a pyrolysis reactor (P) having a reaction zone (R), at least one heating element for setting the desired temperatures, at least one conduit for introducing the polymer mass (A) into the reaction zone (R) and for setting the residence time (Z), and a quencher for cooling down the product mixture (G).

The apparatus particularly preferably comprises, as pyrolysis reactor (P), a fluidized bed reactor, particularly preferably a fluidized bed reactor comprising a fluidized bed of silicon carbide (SiC) in the reaction zone (R), where the silicon carbide preferably has a weight-average particle size of from 20 to 1500 μm, particularly preferably 50 to 1000 μm, optionally resistive heating conductors on the external walls of the reaction zone (R), an evaporator for producing steam, a steam superheater for setting the desired steam temperature, a conduit for introducing the steam into the reaction zone (R) and a quencher for cooling down the product mixture (G).

A further subject of the invention is the use of a styrene copolymer (I) as described above comprising:
Ia) 10% to 99% by weight, based on the styrene copolymer (I), of repeating units (Ia) which originate from styrene; and
Ib) 1% to 90% by weight, based on the styrene copolymer (I), of repeating units (Ib) which originate from a monomer the homopolymers of which have a ceiling temperature of below 350° C., for the production of styrene monomers by thermal depolymerization.

Here, the repeating units (Ib) preferably originate from methyl methacrylate or alpha-methylstyrene, particularly preferably from methyl methacrylate.

Another subject of the invention is also the use of styrene copolymer(s) (I) comprising:
Ia) 10% to 99% by weight, based on the styrene copolymer (I), of repeating units (Ia) which originate from styrene; and
Ib) 1% to 90% by weight, based on the styrene copolymer (I), of repeating units (Ib) which originate from a monomer the homopolymers of which have a ceiling temperature of below 350° C.,
as an additive in the thermal depolymerization of polystyrene.

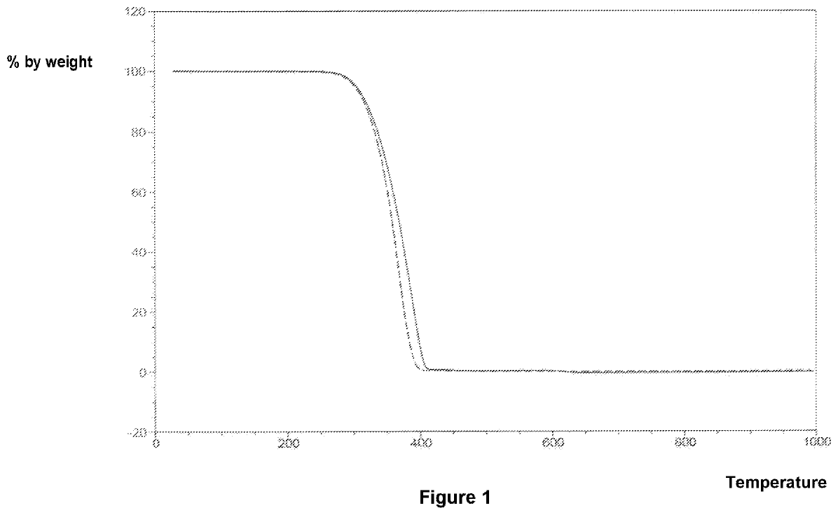

The invention is illustrated by the following examples, FIG. 1 and claims.

### COMPARATIVE EXAMPLE 1

Pure polystyrene (GPPS) having a weight-average molecular weight of 250 000 g/mol and a number-average molecular weight of 100 000 g/mol (measured by means of gel permeation chromatography with polystyrene as standard) was analyzed in a device for thermogravimetric analysis under a nitrogen atmosphere and at a heating rate of 20 K/min. The change in weight (%) over the course of the analysis is shown in FIG. 1 against the temperature (° C.) (example 1: dashed line, comparative example 1: solid line). The composition of the depolymerization products from the polystyrene is shown in table

### Example 1

A copolymer of styrene and methyl methacrylate (S:MMA weight ratio of 70:30, produced by free-radical polymerization) was analyzed in a device for thermogravimetric analysis under a nitrogen atmosphere and at a heating rate of 20 K/min. A typical polymethylmethacrylate has a ceiling temperature of approx. 475 K (202° C.).

The change in weight over the course of the analysis is shown in FIG. 1.

The respective compositions (% by weight) of the depolymerization products are shown in table 1.

TABLE 1

| | Styrene | Styrene | Styrene | Alpha- | Methyl | |
|---|---|---|---|---|---|---|
| | monomer | dimer | trimer | methylstyrene | methacrylate | Other |
| Comparative | 50 | 15 | 10 | 5 | 0 | 20 |
| example 1 | | | | | | |
| Example 1 | 50 | 5 | 5 | 5 | 25 | 10 |

It can clearly be seen from the results that the yield of styrene in the copolymer according to example 1 is just as high as for pure GPPS (comparative example 1), despite the lower proportion of styrene monomers in the copolymer.

At the same time, the proportion of styrene dimers and styrene trimers and other constituents in the depolymerization of the styrene-methyl methacrylate copolymer is lower and the depolymerization proceeds at lower temperatures.

Analogous pyrolyses can be conducted with mixtures of, for example, 60% by weight polystyrene (GPPS) and 40% by weight copolymer of styrene and methyl methacrylate (S:MMA 70:30), or with mixtures containing, for example, 90% by weight polystyrene (GPPS), 4.5% by weight copolymer of alpha-methylstyrene and acrylonitrile (AMSAN), and 5.5% by weight polyethylene (PE).

The process according to the invention for the production of styrene monomers by depolymerization of a styrene-(co)polymer-containing polymer mass accordingly makes it possible to provide the important feedstock styrene in a very high yield with simple breakdown and hence to minimize the formation of styrene oligomers. This can simplify the workup and downstream purification processes.

1-16. (canceled)

17. A thermoplastic molding compound suitable for recycling by thermal depolymerization, consisting of
I) 10% to 99% by weight, based on the total weight of the polymer mass (A), of at least one styrene copolymer (I), comprising:
Ia) 10% to 99% by weight, based on styrene copolymer (I), of repeating units (Ia) which originate from styrene;
Ib) 1% to 90% by weight, based on styrene copolymer (I), of repeating units (Ib); and
Ic) 0% to 10% by weight, based on styrene copolymer (I), of further copolymerizable monomers, and
II) 1% to 90% by weight, based on the total weight of the polymer mass (A), of polystyrene (II), wherein the ceiling temperature of the homopolymer of (Ib) is at least 50 K below the ceiling temperature of the homopolymer of the monomer (Ia).

18. A process for the production of styrene monomers by depolymerization of a styrene-copolymer-containing polymer mass, comprising the steps of:
a) introducing into the reaction zone (R) of a pyrolysis reactor (P) a polymer mass (A) containing:
I) 10% to 99% by weight, based on the total weight of the polymer mass (A), of at least one styrene copolymer (I), comprising:
Ia) 10% to 99% by weight, based on styrene copolymer (I), of repeating units (Ia) which originate from styrene; and
Ib) 1% to 90% by weight, based on styrene copolymer (I), of repeating units (Ib) which originate from a monomer the homopolymers of which have a ceiling temperature of below 350° C., and
II) 1% to 90% by weight, based on the total weight of the polymer mass (A), of polystyrene (II),
b) thermally cleaving the styrene copolymer (I) present in the polymer mass (A) and the polystyrene (II) present in the polymer mass (A) in the reaction zone (R) of the pyrolysis reactor (P) at a temperature of from 300° C. to 1000° C., in order to obtain a product mixture (G) containing styrene monomers and further components;
c) withdrawing the product mixture (G) obtained in step b) from the reaction zone (R) of the pyrolysis reactor (P);
d) cooling the product mixture (G) withdrawn in step c), in order to obtain a condensed product mixture (G′) containing styrene monomers and further components; and
e) separating the styrene monomers from the further components of the condensed product mixture (G′) obtained in step d).

19. The process of claim 18, wherein the average residence time (Z) of the polymer mass (A) in the reaction zone (R) of the pyrolysis reactor (P) is from 0.01 s to 50 s.

20. The process of claim 18, wherein the polymer mass (A), in addition to the at least one styrene copolymer (I), contains:
III) up to 30% by weight, based on the total weight of the polymer mass (A), of polyolefins (III);
IV) up to 4.9% by weight, based on the total weight of the polymer mass (A), of acrylonitrile-based (co)polymers (IV); and
V) up to 4.9% by weight, based on the total weight of the polymer mass (A), of polyesters (V).

21. The process of claim 18, wherein the temperature in the reaction zone (R) of the pyrolysis reactor (P) is 400° C. to 630° C. and the average residence time (Z) of the polymer mass (A) in the reaction zone of the pyrolysis reactor is 0.1 s to 10 s.

22. The process of claim 18, wherein styrene copolymer (I) contains:
Ia) 70% to 98% by weight, based on styrene copolymer (I), of repeating units (Ia) which originate from styrene;
Ib) 2% to 30% by weight, based on styrene copolymer (I), of repeating units (Ib) which originate from a monomer the homopolymers of which have a ceiling temperature of below 350° C.; and
Ic) 0% to 10% by weight, based on styrene copolymer (I), of further copolymerizable monomers selected from the group consisting of maleic anhydride, N-phenylmaleimide, para-methylstyrene, (meth)acrylonitrile, and alkyl acrylate.

23. The process of claim 18, wherein the repeating units (Ib) originate from methyl methacrylate and/or alpha-methylstyrene.

24. The process of claim 18, wherein the repeating units (Ib) originate from methyl methacrylate.

25. The process of claim 18, wherein the pyrolysis reactor (P) is a fluidized bed reactor.

26. The process of claim 25, wherein the fluidized bed reactor comprises a silicon carbide fluidized bed in the reaction zone (R).

27. The process of claim 26, wherein the silicon carbide has a weight-average particle size of from 20 to 1500 μm.

28. The process of claim 18, wherein at least a portion of the further components obtained in step e) is recycled into the reaction zone (R) of the pyrolysis reactor (P).

29. The process of claim 28, wherein the recycling into the reaction zone (R) of the pyrolysis reactor (P) is continuous.

30. The process of claim 18, wherein the further components obtained in step e) which are recycled into the reaction zone (R) of the pyrolysis reactor (P) essentially consist of styrene oligomers.

31. The process of claim 18, wherein, in step d), the product mixture (G) is cooled to a temperature of from 0° C. to 50° C.

32. The process of claim 18, wherein the separation of the styrene monomers in step e) comprises the step of at least one fractional distillation.

33. An apparatus for conducting a process for the production of styrene monomers from the styrene-copolymer-containing polymer mass of claim 18, comprising a pyrolysis reactor (P) having a reaction zone (R), in which the reaction zone (R) and the pyrolysis reactor (P) in the apparatus are configured such that gentle depolymerization of styrene copolymer and polystyrene is possible, wherein the apparatus comprises, as pyrolysis reactor (P), a fluidized bed reactor comprising a fluidized bed of silicon carbide (SiC) having a weight-average particle size of from 20 to 1500 μm in the reaction zone (R), resistive heating conductors on the external walls of the reaction zone (R), an evaporator for producing steam, a steam superheater for setting the desired steam temperature, a conduit for introducing the steam into the reaction zone (R) and a quencher for cooling down the product mixture (G).

34. A process for the production of styrene monomers comprising thermal depolymerization of a styrene copolymer (I) comprising:
Ia) 50% to 85% by weight, based on styrene copolymer (I), of repeating units (Ia) which originate from styrene;
Ib) 15% to 50% by weight, based on styrene copolymer (I), of repeating units (Ib) which originate from a monomer the homopolymers of which have a ceiling temperature of below 350° C.; and
Ic) 0% to 10% by weight, based on styrene copolymer (I), of further copolymerizable monomers selected from the group consisting of maleic anhydride, N-phenylmaleimide, para-methylstyrene, (meth)acrylonitrile, and alkyl acrylate.

35. The process of claim 34, wherein the repeating units (Ib) originate from methyl methacrylate and/or alpha-methylstyrene.

36. The process of claim 34, wherein the repeating units (Ib) originate from methyl methacrylate.
